(19) United States
(12) Patent Application Publication
(10) Pub. No.: US 2006/0025957 A1
(43) Pub. Date: Feb. 2, 2006

(54) Quality assurance system and method

(75) Inventors: Michael A. Lind, Kent, WA (US); Ronald W. Gilbert, Morgan Hill, CA (US); Curtis Lee Carrender, Morgan Hill, CA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: Battelle Memorial Institute, Richland, WA (US)

(21) Appl. No.: 10/902,505

(22) Filed: Jul. 29, 2004

(51) Int. Cl. G01D 1/00

(52) U.S. Cl. 702/127

(57) ABSTRACT

A system for monitoring and controlling a tool that includes a communication circuit associated with the tool and configured to store data regarding the status of the tool and to sense a condition of the tool for quality assurance and quality control. An actuator can be included for altering the operational status of the tool in response to a change in status or a change in condition.

### BACKGROUND OF THE INVENTION

1. Field of the Invention

The present invention pertains to remote quality assurance functions and, more particularly, to devices, systems, and methods for monitoring the condition of tools, instruments, and processes.

2. Description of the Related Art

Tools used in trade and industry must be continually inspected and maintained to ensure they are in proper working order. A tool that is over worn, damaged, or otherwise out of compliance with normal or acceptable specifications poses a danger to those who rely on proper tool performance, such as workers who use the tool and users of a product or process resulting from use of the tool.

The proactive maintenance of tools and machines that produce products and provide services is the management function of quality assurance. More particularly, quality assurance encompasses the systematic organizational activities to implement standards and procedures to ensure products, services, and the processes and tools that provide the same meet specifications. This includes ensuring that tools possess the properties and characteristics to enable production of goods and services that meet customer expectations.

Quality assurance includes the function of quality control, which is typically understood to focus on the inspection and testing of a product or service. Testing broadly includes the execution of predefined activities for determining the extent to which a product or tool possesses desired attributes. Theoretically, quality testing involves verification testing and validation testing. Verification includes inspecting and testing items, such as tools, for conformance and consistency with an associated specification, while validation is the process of determining that what has been defined in the specification is what is actually desired. For purposes of the present invention, the focus is on verification.

Monitoring the integrity of tools requires overhead in terms of man hours for inspection, maintenance, repair, and replacement of tools. Such overhead can include record keeping systems, such as computers, and the labor for collection and entry of data, preparing and reviewing reports, and regular revision and updating of data.

Attempts to automate the quality assurance process includes the use of transducers, and in particular electronic sensors, to monitor conditions in both dynamic and static situations. Sensors, such as piezoelectric devices, including accelerometers, are utilized to provide predictive maintenance and monitoring. The most popular sensor used in industrial applications is the piezoelectric device that displaces an electrical charge when subjected to or strained by an external force. The most popular form of piezoelectric sensor is the crystalline quartz, either in a natural or a reprocessed form, because it is one of the more sensitive and stable piezoelectric materials available. Other materials include polycrystalline and piezoceramics.

The foregoing sensors are used in detecting force applied generally in three basic structural designs, which are flexural, compression, and shear designs. Compression and shear are well known and will not be discussed in detail herein. Flexural designs are directed to detecting bending, typically through the use of a double cantilever beam, such as a beam placed at a centrally-located fulcrum.

Most sensing systems include a sensing element, such as the piezoelectric sensor, which in response to an applied force produces an electrical output signal that must be conditioned prior for analysis and recording. Signal processing is usually accomplished by two different methods, which are shown in FIGS. 1A-1B. In FIG. 1A, a sensing system 10 is shown having a sensor 12 with an internal microelectronic circuit (not shown) for signal conditioning, the output of which is sent to a meter 14 or an oscilloscope 16, or both, by a cable 15. In FIG. 1B, the system 18 utilizes a sensor without electronics (referred to as a charge mode sensor) that is coupled by a cable 19 to a signal conditioner 20 that in turn is coupled by a cable 21 to an output display device such as an oscilloscope 22. Although there have been substantial improvements in the design of such circuits through the use of miniature integrated circuits, the two-wire system using a common conductor for power and signal and an additional conductor for the ground is still used. FIG. 2 is a detailed schematic of the two-wire system 24 in which the sensor 26 is coupled to a signal conditioner 28 by a two-conductor cable 30. The sensor here is a charge mode sensor, which utilizes signal processing electronics that are placed externally. Today, charge mode sensors are generally used in environments that prohibit the use of sensors with built-in electronics.

There is a need, however, for sensors with advanced capabilities to further automate the quality assurance function.

### BRIEF SUMMARY OF THE INVENTION

The disclosed embodiments of the invention are directed to the management of quality assurance, and more particularly to devices, systems, and methods for remote monitoring of the status, condition, and location of tools, instruments, and processes. Throughout the following description, “tool” is used in a broad connotation to mean hand tools, instruments, utensils, and devices or aids for performing work. This includes any devices for doing or facilitating work, including manual devices, power devices, machines, and components of machines. This definition also encompasses instruments, including gauges, precision tools used by specially-trained professionals, agricultural devices, tools of the building trades, and any device essential for performing work.

In accordance with one embodiment of the invention, a quality assurance device is provided that includes a condition sensor configured for association with a tool, such as mounting on a tool or being formed in or with a tool. The condition sensor can be configured to sense conditions that include compression, shear, flexure, tension, vibration, shock, as well as calibration, and other parameters. The device further includes an electronic transceiver that is configured to communicate with the sensor for receiving a condition signal generated by the sensor and to modulate a backscatter communication circuit in response to an interrogation signal.

In accordance with another embodiment of the invention, the device further includes an actuator coupled to a microprocessor in the device that causes the actuator to activate or deactivate an associated tool when an out-of-compliance condition is detected by the sensor or in response to a control signal from the interrogation signal.

In accordance with another aspect of the foregoing embodiment, the condition sensor including a transducer, preferably an integrated circuit, that can include a strain gage transducer utilizing piezoelectric accelerometers or a changing resistance sensor, an infrared sensor, or an optical sensor.

In accordance with another embodiment of the invention, a system is provided for quality assurance management of a remote tool, the system including a condition sensor configured to generate a condition signal of an associated tool; a radio frequency identification tag electrically coupled to the sensor for receiving the condition signal and modulating an interrogation signal for backscatter communication; and an interrogator configured to generate the interrogation signal and to receive the modulated backscatter signal in response thereto.

In accordance with another embodiment of the invention, the system further includes a microprocessor coupled to the interrogator and configured to receive from the interrogator the modulated backscatter signal and to determine therefrom the condition of the tool. Ideally, the computer is also configured to receive from the interrogation signal further data regarding the tool, including the location of the tool, the information regarding calibration of the tool, the data calibrated, the next calibration date, reference numbers used in the calibration, certification numbers, employee identification, history, history of tool use, history of tool users, and the like.

In accordance with another embodiment of the invention, a method of quality assurance is provided, the method including providing a sensor of a condition of an associated tool; providing a transponder device coupled to the sensor to receive a condition signal from the sensor and to modulate an interrogation signal for backscatter communication with the interrogator; sensing a condition of one from among stress, strain, shear, compression, tension, flexure, vibration, shock, and calibration and generating a sense condition signal; and modulating a received interrogation signal with the sensed condition signal.

In accordance with another aspect of the foregoing embodiment, the modulation of the received interrogation signal with the sensed condition signal is stored in a memory device that is periodically updated in accordance with a predetermined schedule. In addition, the method can include generating a control signal in response to the condition signal to change the operational status of the tool.

### BRIEF DESCRIPTION OF THE SEVERAL VIEWS OF THE DRAWING(S)

The foregoing and other features and embodiments of the invention will be more readily appreciated as the same become better understood from the following detailed description when taken in conjunction with the accompanying drawings, wherein

FIGS. 1A and 1B are diagrams of conventional sensing systems;

FIG. 2 is an electrical schematic of a piezoelectric sensing system;

FIG. 3 is a diagram illustrating a radio frequency communication circuit for use with the present invention;

FIGS. 4A-4C are cross-sectional illustrations of a force sensor, pressure sensor, and accelerometer, respectively;

FIG. 5 is a schematic of an apparatus formed in accordance with the present invention wherein a radio frequency device is associated with a tool; and

FIG. 6 is a block diagram of a system formed in accordance with the present invention.

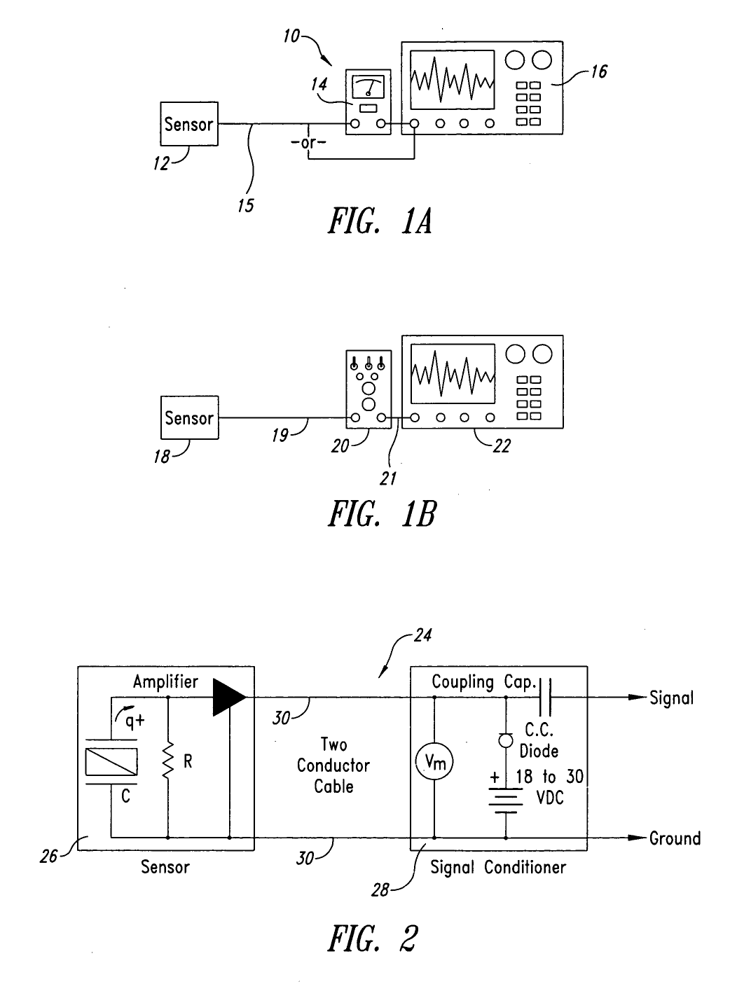

### DETAILED DESCRIPTION OF THE INVENTION

The disclosed embodiments of the invention are directed to a quality assurance system in which radio frequency identification equipment is utilized with embedded or attached sensors to provide effective monitoring and control and other quality assurance and quality control functions in a wide range of tools, as defined above. Referring initially to FIG. 3, shown therein is one form of wireless or radio frequency (RF) communication utilized in the present invention.

Radio frequency identification (RFID) tag systems have been developed that facilitate monitoring of remote objects. As shown in FIG. 3, a basic RFID system 40 includes two components: an interrogator or reader 42, and a transponder (commonly called an RF tag) 44. The interrogator 42 and RF tag 44 include respective antennas 46, 48. In operation, the interrogator 42 transmits through its antenna 46 a radio frequency interrogation signal 50 that is received at the antenna 48 of the RF tag 44. In response to receiving the interrogation signal 50, the RF tag 44 produces an amplitude-modulated response signal 52 that is modulated back to the interrogator 42 through the tag antenna 48 by a process known as backscatter communication.

The conventional RF tag 44 includes an amplitude modulator 54 with a switch 56, such as a MOS transistor, connected between the tag antenna 48 and ground. When the RF tag 44 is activated by the interrogation signal 50, a driver (not shown) creates a modulating on/off signal 57 based on an information code, typically an identification code, stored in a non-volatile memory (not shown) of the RF tag 44. The modulating signal 57 is applied to a control terminal of the switch 56, which causes the switch 56 to alternately open and close. When the switch 56 is open, the tag antenna 48 reflects a portion of the interrogation signal 50 back to the interrogator 42 as a portion 58 of the response signal 52. When the switch 56 is closed, the interrogation signal 50 travels through the switch 56 to ground, without being reflected, thereby creating a null portion 59 of the response signal 52. In other words, the interrogation signal 50 is amplitude-modulated to produce the response signal 52 by alternately reflecting and absorbing the interrogation signal 50 according to the modulating signal 57, which is characteristic of the stored information code. The RF tag 44 could also be modified so that the interrogation signal is reflected when the switch 56 is closed and absorbed when the switch 56 is open. Upon receiving the response signal 52, the interrogator 42 demodulates the response signal 52 to decode the information code represented by the response signal. The conventional RFID systems thus operate with an oscillator or clock in which the RF tag 44 modulates a RF carrier frequency to provide an indication to the interrogator 42 that the RF tag 44 is present.

The substantial advantage of RFID systems is the non-contact, non-line-of-sight capability of the technology. The interrogator 42 emits the interrogation signal 50 with a range from one inch to one hundred feet or more, depending upon its power output and the radio frequency used. Tags can be read through a variety of materials and substances, such as paper, cardboard, wood, fog, ice, paint, dirt, and other visually and environmentally challenging conditions where bar codes or other optically-read technologies would be useless. RF tags can also be read at remarkable speeds, in most cases responding in less than one hundred milliseconds.

A typical RF tag system 40 often contains a number of RF tags 44 and the interrogator 42. RF tags are divided into three main categories. These categories are beam-powered passive tags, battery-powered semi-passive tags, and active tags. Each operates in fundamentally different ways.

The beam-powered RF tag is often referred to as a passive device because it derives the energy needed for its operation from the interrogation signal beamed at it. The tag rectifies the field and changes the reflective characteristics of the tag itself, creating a change in reflectivity that is seen at the interrogator. A battery-powered semi-passive RF tag operates in a similar fashion, modulating its RF cross-section in order to reflect a delta to the interrogator to develop a communication link. Here, the battery is the source of the tag's operational power. Finally, in the active RF tag, a transmitter is used to create its own radio frequency energy powered by the battery.

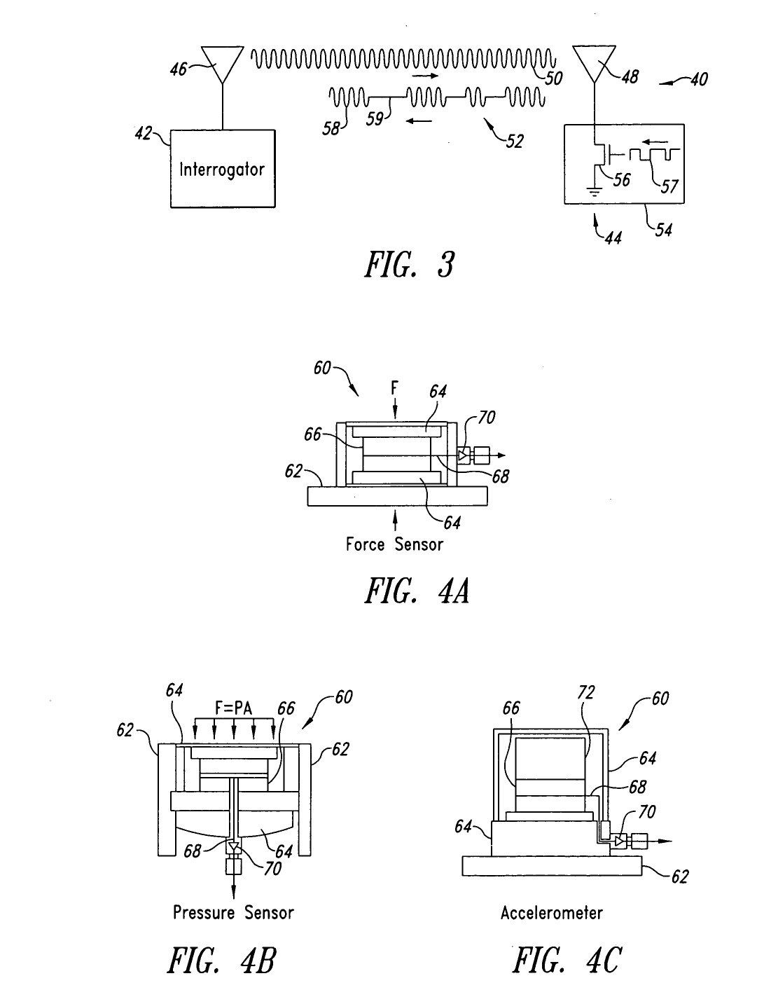

Referring next to FIGS. 4A-4C, shown therein are three different types of sensors for use with wireless communication devices, such as the RFID system described above. As shown in FIGS. 4A-4C, a sensor 60 is illustrated in cross-section wherein a test structure 62 is associated with the sensor housing 64. Contained within the housing 64 are piezoelectric crystals 66 configured to generate a charge when subjected to an external force. An electrode 68 carries the charge from the crystals to a conditioning circuit 70 for subsequent processing. The force sensor 60 shown in FIG. 4A is configured to monitor compression, while the sensor 60 of FIG. 4B is configured to monitor pressure applied from one direction, and the accelerometer of FIG. 4C incorporates a mass 72. While each of the sensors differ very little in internal configuration, the accelerometer of FIG. 4C measures motion such that the mass 72 is forced by the crystals to follow the motion of the structure to which it is attached. The resulting force on the crystals is calculated as shown by the formula in FIG. 4C as F=MA. The pressure and force sensors also rely on external force to string the crystals, with the pressure sensor utilizing a diaphragm arrangement to collect pressure, which in this case is calculated as F=PA, where P equals pressure and A equals area. The disclosed embodiments of the present invention are intended to utilize such sensors as shown in FIGS. 4A-4C as well as other monitoring devices known to those skilled in the art, including optical, infrared, ultrasonic, and the like. Hence, the present invention is not to be limited by the preferred embodiments disclosed and described herein. Moreover, the sensed conditions include one or more of the following: stress, strain, compression, shear, flexure, tension, vibration, shock, and calibration, as well as the level and duration thereof.

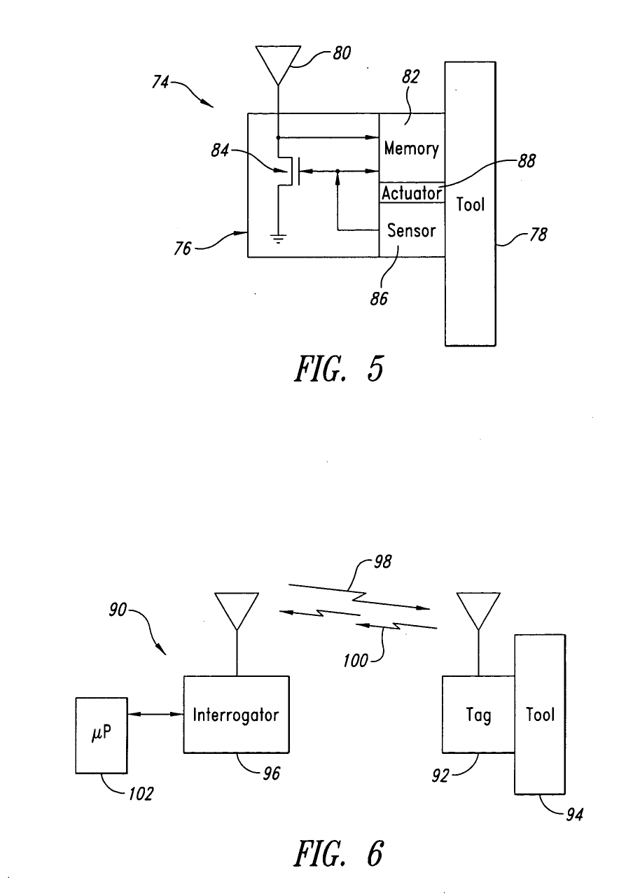

FIG. 5 illustrates an apparatus 74 in which a communication circuit 76 is associated with a tool 78 for storing data regarding the status of the tool. The status can include such things as the operational status, qualification status, location, theft detection, inventory accounting, identification and certification numbers, calibration dates, user information, instructions, and history of use.

As shown in FIG. 5, the communication circuit 76 includes an antenna 80 configured to receive radio frequency communications and to reflect the same using backscatter communication as described above. Signals received on the antenna 80 are, in one embodiment, processed by the circuit 76 to extract operational power using known circuitry which will not be described in detail herein. Alternatively, the communication circuit 76 can be powered by an internal power source, such as a battery, or an external power source suitable to the application. As shown in FIG. 5, the communication circuit 76 is a passive device that relies on power extracted from the received radio frequency signals for its operation.

In one embodiment, the received radio frequency signals are stored in a memory 82 in a conventional write operation, which stored information or data can be used to modulate the radio frequency signal, such as through the MOS transistor 84. The memory is thus used to store the data regarding the status of the tool, which can be updated by the received radio frequency signals.

In another embodiment shown in FIG. 5, the communication circuit 76 further includes a sensor 86 that is associated with the tool 78 for sensing at least one condition of the tool. The condition can include things such as stress or strain on the tool, vibration, shock, temperature, tool movement, and any other condition that can be sensed using known sensing and detection equipment. The information from the sensor can be used directly to modulate the received radio frequency signal, stored in the memory 82, or both. In addition, it is to be understood that more than one sensor may be used with one communication circuit 76.

Association of the communication circuit 76 with the tool 78 can be done by a variety of methods, all dependent on the type of tool. For example, the sensor 86 can be embedded in the tool 78, integrally formed with the tool 78, or attached or affixed to an internal or external surface of the tool 78.

In yet another embodiment, an actuator 88 is also provided that is coupled to the tool to activate or deactivate the tool or otherwise change its operational characteristics. The actuator 88 can be coupled to one or more of the antenna 80, the memory 82, and the sensor 86 for responding to the radio frequency signals received on the antenna 80, from an instruction stored in the memory 82, or from a condition sensed by the sensor 86, or any combination of the foregoing. For example, if the sensor 86 detects a level of shock in the tool 78 that is outside a parameter stored in the memory 82, the actuator 88 can change the operational status of the tool 78, such as shutting it down or lowering its level of performance responsive to the level of shock. The level of the sensed shock can also be stored in memory or used to modulate an interrogation signal received on the antenna 80 for communication with a remote device or both.

In yet another embodiment, a clock (not shown) can be included in the communication circuit 76 for timing and calendaring purposes. This clock can be powered by an internal power source, such as a battery or other charge storage device or by an outside power source.

Referring next to FIG. 6, shown therein is a system 90 in which an RFID tag 92 is associated with a tool 94. The tag 92 can take the form of the apparatus 74 described above with respect to FIG. 5, and is associated with the tool 94 in the manner described above with respect to FIG. 5. The system further includes an interrogator 96 configured to transmit interrogation signals 98 to the tag 92, which is configured to return modulated signals 100 via backscatter communication. The interrogator 96 is configured to receive and process the modulated signals 100 using known technology.

The interrogator 96 can be a hand held device that one can use to periodically verify the presence and operational status or operational condition or both of the tool 94. In another embodiment, the interrogator 96 can be fixedly mounted in a room, container, or other structure for monitoring the presence of tagged tools 94 within its range. In addition, the interrogator 96 can be coupled to a microprocessor 102 that in turn ca be coupled to a local or worldwide network of computers. In this manner, control of the operational status or condition of the tool 94 can be effected through commands entered at a user's terminal, which are then sent to the interrogator 96 for transmission to the tag 92.

In one embodiment, the interrogator transmits status information to the tag 92 for use in identifying and monitoring the tool 94 as described above with respect to the apparatus 74 of FIG. 5. This information is written to the tag's memory.

Because weight and size are important in many applications, it is desirable that the size of the tag 92 with the associated sensor, memory, and actuator circuits and components be as small and lightweight and energy efficient as possible. Hence, a piezoelectric sensor such as that described above in FIGS. 4A-4C that generates a small charge when the crystals are subjected to a force would be one means of sensing a condition of the tool and generating a signal that can be used to modulate an interrogation signal. It is to be understood, however, that signal conditioning circuits can be included, as necessary, for processing the generated signal from the sensor prior to its use in modulation of the interrogation signal, storage and memory. Operational power for the conditioning circuit comes from the interrogation signal itself, from a stored charge, or from an external power source or any combination of the foregoing.

From the foregoing it will be appreciated that, although specific embodiments of the invention have been described herein for purposes of illustration, various modifications may be made without deviating from the spirit and scope of the invention. For example, the sensor circuit can be affixed to the tool and then hardwired to the communication circuit, which can be located away from the tool. In addition, a clock circuit can be included in the tag for timing of events, such as an associated status of the tool or condition of the tool. Resetting of the clock can be done in response to an interrogation signal or automatically such as periodically.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

It will be understood that the present invention can have application to many processes, such as fields of technology that require process certification, i.e., drug preparation or production of heavy liability items.

Accordingly, the invention is not limited except as by the appended claims and the equivalents thereof.

1. A device for monitoring status of a tool, comprising:
means for associating the device with the tool; and
a communication circuit coupled to a data structure and configured to store data regarding the status of the tool and to modulate a radio frequency interrogation signal in accordance with the stored data.

2. The device of claim 1 wherein the stored data comprises one or more from among stress level, vibration level, shock level, elapsed time, calibration, location, calibration date, certification number, next calibration date, number of uses, tool user information, history of tool use, use instructions, and operational status.

3. The device of claim 2 wherein the communication circuit comprises a data structure for storing the data.

4. The device of claim 3 wherein the data structure comprises a memory device.

5. The device of claim 1, further comprising a clock circuit coupled to the communication circuit for timing an associated status of the tool.

6. The device of claim 5 wherein the clock is configured to reset in response to an interrogation signal.

7. The device of claim 1 wherein the means for associating the device with the tool comprises means for affixing the device to the tool.

8. The device of claim 1 wherein the communication circuit is configured to extract operational power from a received radio frequency interrogation signal.

9. The device of claim 1, further comprising means for changing an operational condition of the tool in response to a change in the stored data regarding the status of the tool or in response to a change in the sensed condition of the tool.

10. A device for monitoring a tool, comprising:
a sensor in physical association with the tool and configured to sense at least one condition of the tool and to generate a data signal in response to sensing the at least one condition of the tool;
a communication circuit coupled to the sensor and configured to receive the data signal and to modulate a received radio frequency interrogation signal with the data signal in response to the interrogation signal.

11. The device of claim 10 wherein the at least one condition comprises one or more from among stress, strain, vibration, shock, compression, shear, flexure, tension, and calibration.

12. The device of claim 11 wherein the communication circuit comprises a data structure configured to store the data signal.

13. The device of claim 12 wherein the data structure is further configured to store data regarding status of the tool, the status data comprising one or more of from among stress level, strain level, compression level, shear level, flexure level, tension level, vibration level, shock level, elapsed time, calibration, location, calibration date, certification number, next calibration date, number of uses, tool user information, history of tool use, use instructions, and operational status.

14. The device of claim 10 wherein the communication circuit is configured to extract operational energy from the interrogation signal for backscatter radio frequency communication.

15. The device of claim 14 wherein the sensor is configured to generate the data signal in response to a change in at least one condition of the tool using current generated by a change in the sensor structure.

16. The device of claim 15 wherein the sensor comprises a piezoelectric sensor.

17. The device of claim 16, comprising means for associating the sensor with the tool.

18. The device of claim 17 wherein the associating means comprises means for affixing the sensor to the tool.

19. The device of claim 10, further comprising means for changing an operational condition of the tool in response to a change in the stored data regarding the status of the tool or in response to a change in the sensed condition of the tool.

20. An apparatus, comprising:
a tool;
a device for monitoring status of the tool, the device comprising:
means for associating the device with the tool; and
a communication circuit configured to store data regarding the status of the tool and to modulate a radio frequency interrogation signal in accordance with the stored data.

21. The apparatus of claim 20 wherein the device further comprising a sensor configured to sense at least one condition of the tool and to generate a data signal to the communication circuit corresponding to the sensed at least one condition, and the communication circuit configured to modulate the received radio frequency interrogation signal in accordance with the sensed at least one condition.

22. The apparatus of claim 21 wherein the data regarding the status of the tool comprises one or more of from among stress level, strain level, compression level, shear level, flexure level, tension level, vibration level, shock level, elapsed time, calibration, location, calibration date, certification number, next calibration date, number of uses, tool user information, history of tool use, use instructions, and operational status;
further wherein the at least one condition of the tool comprises one or more from among stress, strain, vibration, shock, and calibration.

23. The apparatus of claim 21 wherein the sensor comprises a piezoelectric sensor configured to generate a signal in response to a change in at least one condition of the tool using current generated only by a change in the sensor.

24. The apparatus of claim 20, further comprising means for changing an operational condition of the tool in response to a change in the stored data regarding the status of the tool or in response to a change in the sensed condition of the tool.

25. A system, comprising:
means for associating the device with the tool;
a communication circuit coupled to a data structure and configured to store data regarding the status of the tool and to modulate a radio frequency interrogation signal in accordance with the stored data; and
an interrogator configured to transmit the radio frequency interrogation signals.

26. The system of claim 25 wherein the device further comprises a sensor configured to sense at least one condition of the tool and to generate a data signal.

27. The system of claim 26 wherein the data regarding the status of the tool comprises one or more of from among stress level, strain level, compression level, shear level, flexure level, tension level, vibration level, shock level, elapsed time, calibration, location, calibration date, certification number, next calibration date, number of uses, tool user information, history of tool use, use instructions, and operational status;
further wherein the at least one condition of the tool comprises one or more from among stress, strain, vibration, shock, and calibration.

28. The system of claim 27, further comprising a microprocessor coupled to the interrogator and configured to receive data from the interrogator regarding the status of the tool and the condition of the tool.

29. The system of claim 26 wherein the device further comprises an apparatus for changing the operational status of the tool in response to a change in the status of the tool or in response to a sensed change in the condition of the tool.

30. A method for monitoring a tool, the method comprising:
providing means for associating a monitoring device with the tool;
providing the device with a communication circuit configured to store data regarding the status of the tool and to modulate a radio frequency interrogation signal in accordance with the stored data.

31. The method of claim 30, further comprising providing an interrogator to transmit the radio frequency interrogation signal and to receive a backscattered radio frequency signal from the device.

32. A method for monitoring a tool, comprising:
associating a sensor with the tool;
sensing at least one condition regarding the tool and generating a data signal in response to the sensed at least one condition; and
modulating a received radio frequency interrogation signal in accordance with the data signal.

33. The method of claim 32, further comprising:
storing the data signal in a memory; and
sensing a changed condition of the tool and updating the stored data in the memory in response thereto.

34. The method of claim 33, further comprising generating a control signal to change an operational status of the tool in response to sensing at least one condition of the tool.
